(19) United States
(12) Patent Application Publication
(10) Pub. No.: US 2015/0351577 A1
(43) Pub. Date: Dec. 10, 2015

(54) COOKER AND METHOD FOR COOKING FOOD

(71) Applicant: KONINKLIJKE PHILIPS N.V., Eindhoven (NL)

(72) Inventors: JINGWEI TAN, EINDHOVEN (NL); FEI XUE, EINDHOVEN (NL)

(21) Appl. No.: 14/655,460

(22) PCT Filed: Dec. 26, 2013
(86) PCT No.: PCT/IB2013/061336

§ 371 Date: Jun. 25, 2015

(30) Foreign Application Priority Data
Dec. 27, 2012 (CN) PCT/CN2012/087666

(51) Int. Cl. A47J 27/00; A23L 1/01

(52) U.S. Cl. CPC A47J 27/002; A23L 1/01; A23V 2002/00

(57) ABSTRACT

The invention proposes a cooker, comprising: a container, configured to receive food; a vibration generator coupled with the container, configured to generate vibration; and a controller coupled with the vibration generator, configured to control the vibration generator to vibrate the container to cause food movement in the container. The invention also proposes a method of cooking food in a container, comprising the steps of: heating the food in the container; and controlling a vibration generator to vibrate the container so as to cause the food in the container to move during the heating process.

### FIELD OF THE INVENTION

The invention relates to food cooking, and particularly relates to cookers and methods for cooking food in a container, during which food is controlled to move in the container.

### BACKGROUND OF THE INVENTION

Nowadays, various kinds of cookers have been emerging in the market to meet consumers' requirements. While preparing some of the dishes, food is typically required to be stirred during cooking so as to achieve a good balance between nutrition preservation and taste enhancement. One traditional method is to stir food manually during cooking to make the food well mixed and/or to prevent the food burned; however such a method is laborious and inconvenient, thus resulting in an undesired user experience. A developed approach is using a cooker with a stirring-impeller inside; with the stirring-impeller, the stirring of food can be achieved automatically.

FIG. 1 shows an existing developed cooker 900 with a stirring-impeller. Referring to FIG. 1, the container 902 includes a stirring-impeller 904 arranged at its bottom. Food to be cooked is received within the container 902. During cooking, the stirring-impeller 904 is controlled to rotate around a central shaft 906 clockwise or counter-clockwise. The rotation of the stirring-impeller 904 renders the food in the container 902 to move, and thereby the stirring of food during cooking is accomplished. Such a cooker enables automatic food stirring during cooking; however its stirring mode is relatively boring and less attractive, namely, the food can only move along with the movement track of the stirring-impeller. Moreover, with the stirring-impeller arranged at the bottom of the container, the cleaning of container becomes time-consuming.

### OBJECT AND SUMMARY OF THE INVENTION

In view of the issues stated above, it would be advantageous to achieve a cooker and a method for cooking food, with which the food can be controlled to move as desired during cooking without a stirring-impeller. It would also be desirable to achieve a cooker and a method for cooking food, with which the food is controlled to move and its movement modes can be adjusted as desired during cooking.

Based on the above concerns, in one aspect, one embodiment of the invention provides a cooker. The cooker comprises: a container configured to receive food; a vibration generator coupled with the container, configured to generate vibration; and a controller coupled with the vibration generator, configured to control the vibration generator to vibrate the container to cause food movement horizontally in the container.

As the vibration generator, which may typically be positioned below the container instead of within the container, serves as a module to cause food horizontal movement in the container, the cooker of the invention enables the food in the container to move as desired without a stirring-impeller. Thus, the cleaning of the container would be easier compared with traditional stirring-impeller solution.

In one embodiment, the vibration generator may comprise a first vibrator, and the controller is configured to control the first vibrator to vibrate the container to cause food reciprocating movement in a first horizontal direction in the container.

Advantageously, the vibration generator may further comprise a second vibrator, and the controller is further configured to control the second vibrator to vibrate the container to cause food reciprocating movement in a second horizontal direction in the container, and the second horizontal direction has an angle related to the first horizontal direction.

Advantageously, the first horizontal direction is perpendicular to the second horizontal direction.

As the vibration generator comprising two vibrators with vectors perpendicular to each other, the controller may further be configured to adjust the phase change and/or vibration amplitude of the two vibrators separately so as to change the movement track of the food.

In this embodiment, different movement tracks of the food horizontally in the container could be achieved by adjusting the phase change of the two vibrators and/or the vibration amplitudes of the two vibrators. Namely, the movement of the food can be controlled to shift between different movement tracks as desired during cooking by adjusting the phase change of the two vibrators and/or the vibration amplitudes of the two vibrators, which contributes to a flexible control strategy of food movement and rich movement patterns.

Advantageously, the vibration generator may comprise an eccentric vibrator, an electromagnetic vibrator and so forth.

In one embodiment, the first vibrator is an eccentric vibrator, and the controller is configured to adjust the vibration amplitude of the eccentric vibrator so as to change the movement diameter of the food.

Advantageously, the second vibrator is an eccentric vibrator as well. As the vibration generator comprising two eccentric vibrators with vectors perpendicular to each other, the controller may be further configured to adjust the phase change and/or vibration amplitude of the eccentric vibrators separately, so as to change the movement track of the food.

Advantageously, the eccentric vibrator is solidity coupled with the container, and the container or the vibration generator is flexibly supported by a spring.

In this embodiment, different movement tracks of the food horizontally in the container could be achieved by adjusting the phase change of the two eccentric vibrators and/or the vibration amplitudes of the two eccentric vibrators. Namely, the movement of the food can be controlled to shift between different movement tracks as desired during cooking by adjusting the phase change of the two eccentric vibrators and/or the vibration amplitudes of the two eccentric vibrators, which contributes to a flexible control strategy of food movement and rich movement patterns.

In another embodiment, the first vibrator is an electromagnetic vibrator, and the controller is configured to adjust the magnetic intensity of the electromagnetic vibrator, so as to change the movement diameter of the food.

Advantageously, the electromagnetic vibrator comprising a magnet and an electromagnet; the magnet solidity coupled with the container, and the magnet or the container is flexibly supported by a spring.

Advantageously, the second vibrator is electromagnetic vibrator as well, and the controller is configured to adjust the phase change and/or magnetic intensity of the electromagnetic vibrators separately, so as to change the movement track of the food horizontally. As the vibration generator comprising two electromagnetic vibrators with vectors perpendicular to each other, the controller may further be configured to adjust the phase change and/or the magnetic intensity of the two electromagnetic vibrators separately so as to change the movement track of the food.

Advantageously, the electromagnetic vibrators comprising a magnet and two electromagnets; the magnet solidity coupled with the container, and the magnet or the container is flexibly supported by a spring.

In this embodiment, different movement tracks of the food horizontally in the container could be achieved by adjusting the phase change of the two electromagnetic vibrators and/or the magnetic intensity of the two electromagnetic vibrators. Namely, the movement of the food can be controlled to shift between different movement tracks as desired during cooking by adjusting the phase change of the two electromagnetic vibrators and/or the magnetic intensity of the two electromagnetic vibrators, which contributes to a flexible control strategy of food movement and rich movement patterns.

In another aspect, one embodiment of the invention provides a method of cooking food in a container, the method comprising the steps of: heating the food in the container; and controlling a vibration generator to vibrate the container so as to cause the food in the container to move horizontally during the heating process.

Advantageously, the vibration generator comprises a first vibrator, and the controller is configured to control the first vibrator to vibrate the container to cause food reciprocating movement in a first horizontal direction in the container; the vibration generator further comprises a second vibrator, and the controller is further configured to control the second vibrator to vibrate the container to cause food reciprocating movement in a second horizontal direction in the container, and the second horizontal direction has an angle related to the first horizontal direction; and the controller is further configured to adjust the phase change and/or vibration amplitude of the first and second vibrators separately, so as to change the movement track of the food in the container.

### BRIEF DESCRIPTION OF THE DRAWINGS

The above and other objects and features of the present invention will become more apparent from the following detailed description considered in connection with the accompanying drawings, in which:

FIG. 1 shows an existing cooker with a stirring-impeller;

FIG. 2 shows an exemplary cooker according to one embodiment of the invention;

FIG. 3a shows an embodiment of the cooker of FIG. 2, in which the vibration generator includes an eccentric vibrator;

FIG. 3b shows an embodiment of the cooker of FIG. 2, in which the vibration generator includes an electromagnetic vibrator;

FIG. 4 shows an embodiment of the cooker of FIG. 2, in which the vibration generator includes two vibrators;

FIG. 5 shows a plurality of movement tracks that may be achieved by the two vibrators of FIG. 4; and

FIG. 6 shows a flow chart of a method of cooking food in a container according to one embodiment of the invention.

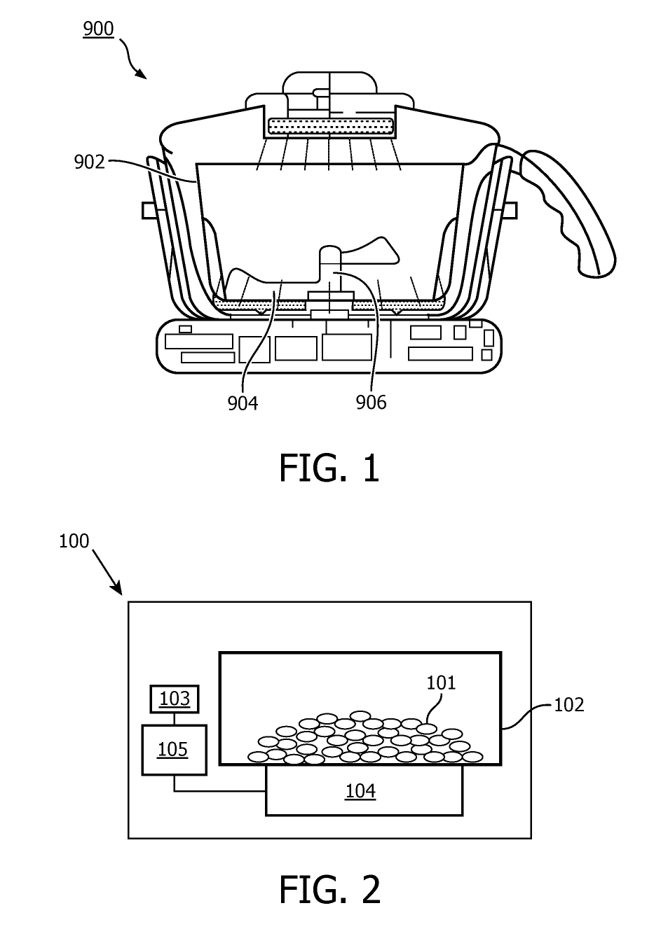

Throughout the above drawings, like reference numerals will be understood to refer to like, similar or corresponding features or functions.

### DETAILED DESCRIPTION

Reference will now be made to embodiments of the invention, one or more examples of which are illustrated in the figures. The embodiments are provided by way of explanation of the invention, and are not meant as a limitation of the invention. For example, features illustrated or described as part of one embodiment may be used with another embodiment to yield still a further embodiment. It is intended that the invention encompass these and other modifications and variations as come within the scope and spirit of the invention.

FIG. 2 shows an exemplary cooker 100 according to one embodiment of the invention. Cooker 100 includes a container 102 for receiving food 101. Container 102 may be of any shape suited to contain food; container 102 may be made of metal, glass or other materials with good thermal conductivity. Advantageously, the inner wall of container 102 may be coated with no-stick material, so container 102 will be easy to be cleaned up after usage.

Cooker 100 may further include a heater 103 configured to heat food 101 in container 102. Various types of heaters may be used herein to generate heat, for example, a wire heater, an induction heater, a hot air heater, a steam heater, or their combination. Heater 103 may be arranged at any suitable position where heat generated by it can be transferred to food 101 by conductivity and/or convection and/or radiation. For example, heater 103 may be disposed at the bottom of container 102, at the top of container 102, at the sidewall of container (as shown in FIG. 2) or their combination.

Cooker 100 further includes a vibration generator 104 configured to generate vibration to vibrated container 102 during cooking. Vibration generator 104 may be arranged at any suitable position where the vibration of container 102 can be achieved, for example, vibration generator 104 may be arranged below container 102 so as to generate vibration at the bottom of container 102, as shown in FIG. 2. Vibration generator 104 may take on various forms, for example, an eccentric vibrator, an electromagnetic vibrator, a pair of eccentric vibrators, a pair of electromagnetic vibrators and so forth. Detailed description of vibration generator 104 will be given in the following text.

Cooker 100 further includes a controller 105 electrically coupled with vibration generator 104 and configured to control vibration generator 104 to vibrate container 102 so as to cause food movement in container 102 during cooking. Controller 105 may be a micro control unit (MCU), for example. The movement direction and/or movement mode of food 101 in container 102 depends on the type of vibration generator 104 and the control strategy of controller 105, which will be described below in details.

In one embodiment, controller 105 may control vibration generator 104 to vibrate container 102 to cause food reciprocating movement in a substantially horizontal direction in container 102. In this regard, vibration generator 104 may be an eccentric vibrator, an electromagnetic vibrator, or any other vibrator that is suitable for achieving the horizontal movement of food 101 in container 102.

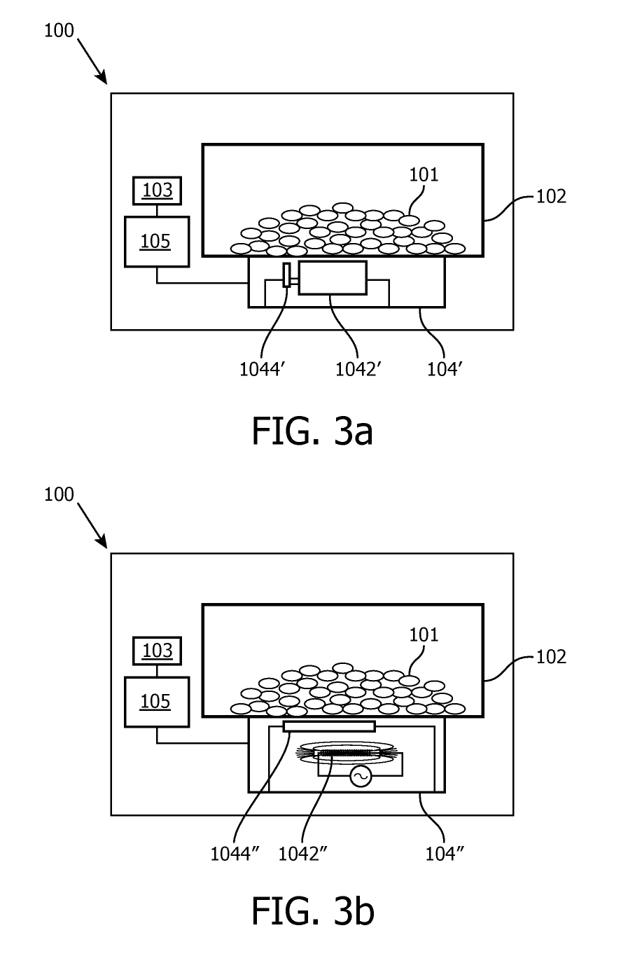

To be specific, as shown in FIG. 3a, eccentric vibrator 104′ may include a driving unit 1042′ coupled with an eccentric weight 1044′. When eccentric vibrator 104′ is activated, driving unit 1042′ (e.g., a motor) starts to rotate and the rotation of driving unit 1042′ spins eccentric weight 1044′, thereby producing vibration in a horizontal direction. As eccentric vibrator 104′ is solidity coupled with container 102, and the container or the vibration generator is flexibly supported by a spring, the vibration of eccentric vibrator 104′ renders food 101 in container 102 to move in a substantially horizontal direction. Apart from the primary horizontal movement, food 101 may also move vertically in a disordered manner.

During cooking, controller 105 may control eccentric vibrator 104′ to generate vibration in response to a trigger. The trigger may be a start signal input by a user through an interface on cooker 100, or a signal generated when an internal timer expires. Furthermore, controller 105 may also control eccentric vibrator 104′ to stop vibrating, for example after a predetermined duration has elapsed or when a stop signal input by the user through the interface has been received.

Moreover, to achieve the shift of movement modes of food 101 during cooking, advantageously, controller 105 may also adjust the vibration amplitude of eccentric vibrator 104′ by adjusting the power supplied to eccentric vibrator 104′, in response to a mode-changing signal input by the user or a signal generated when a preset duration passes for example, so as to change the movement diameter of food 101 in the horizontal direction in container 102. For example, in response to a start signal, controller 105 may control eccentric vibrator 104′ to vibrate container 102 to cause food 101 reciprocating movement at a first diameter, for example 10 cm, in the horizontal direction in container 102; then in response to a mode-changing signal, controller 105 may adjust the power supplied to eccentric vibrator 104′ and thus the vibration amplitude of eccentric vibrator 104′ to cause food 101 reciprocating movement at a second diameter, for example at 15 cm, in the horizontal direction. It is to be noted that during the whole cooking procedure, controller 105 may adjust the movement modes of food 101 for several times as desired or as required.

As shown in FIG. 3b, electromagnetic vibrator 104″ may include an electromagnetic coil 1042″ and a magnet 1044″. When electromagnetic vibrator 104″ is powered on, electromagnetic coil 1042″ generates a magnetic field to cause magnet 1044″ to vibrate. As magnet 1044″ is rigidity coupled with container 102, and the magnet or the container is flexibly supported by a spring, the vibration of magnet 1044″ urges food 101 in container 102 to move in a substantially horizontal direction. Apart from the primary horizontal movement, food 101 may also move vertically in a disordered manner.

The control strategy of controller 105 for electromagnetic vibrator 104″ may be similar to that of eccentric vibrator 104′, which will not be described in details for simplicity, and the slight difference lies in that controller 105 may adjust the magnetic intensity of electromagnetic coil 1042″ by adjusting the power supplied to electromagnetic coil 1042″ so as to change the movement diameter of food 101 in the horizontal direction in container 102.

Hereinafter, the control strategy of controller 105 will be described using at least two vibrators with vectors perpendicular to each other as an illustrative example of vibration generator 104.

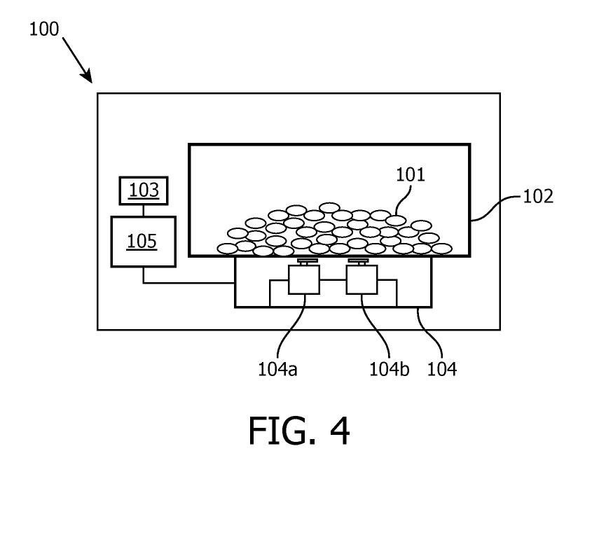

As shown in FIG. 4, the vibration generator comprises two vibrators, a first vibrator 104a and a second vibrator 104b. The first vibrator 104a is configured to vibrate the container to cause food reciprocating movement in a first horizontal direction in the container, and the second vibrator is configured to vibrate the container to cause food reciprocating movement in a second horizontal direction in the container. The second horizontal direction has an angle related to the first horizontal direction; advantageously, the second horizontal direction is perpendicular to the first horizontal direction. A plurality of movement modes/tracks of food 101 may be achieved by adjusting the phase change of vibrators 104a, 104b and/or vibration amplitudes of vibrators 104a, 104b.

The motion tracks of vibrators 104a, 104b (denoted by “x” and “y” respectively) can be expresses as:

x=A₁ cos(ωt+φ₁)

y=A₂ cos(ωt+φ₂)

where A₁ and A₂ represent the vibration amplitudes of vibrators 104a, 104b respectively; φ₁ and φ₂ represents the phases of vibrators 104a, 104b respectively.

The equation of synthesis of x and y is as follows:

$$\frac{{x}^{2}}{{A}_{1}^{2}} + \frac{{y}^{2}}{{A}_{2}^{2}} - \frac{2 xy}{{A}_{1} {A}_{2}} cos ( {ϕ}_{2} - {ϕ}_{1} ) = {sin}^{2} ( {ϕ}_{2} - {ϕ}_{1} )$$

where (φ₂−φ₁) represents the phase change of vibrators 104a, 104b.

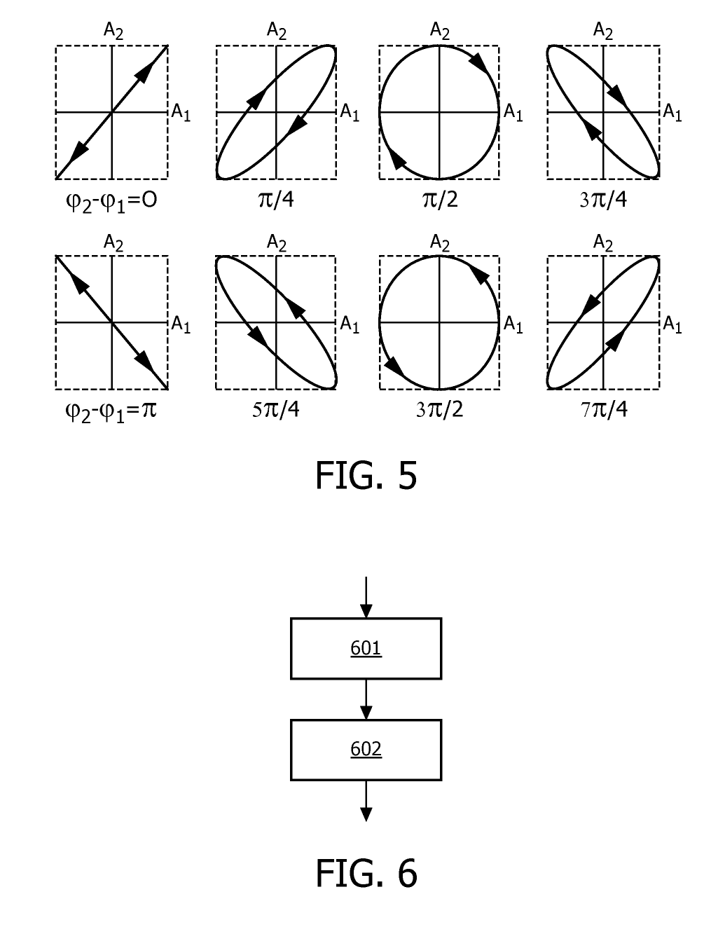

By adjusting the phase change (φ₂−φ₁) of vibrators 104, 104b and/or the vibration amplitudes A₁, A₂ of vibrators 104a, 104b, a plurality of movement modes/tracks of food 101 in container 102 may be obtained. FIG. 5 shows eight movement tracks of food 101, in which A₁≠A₂, φ₂−φ₁=0, π/4, π/2, 3π/4, π, 5π/4, 3π/2 or 7π/4. As can be seen from FIG. 5, when the phase change (φ₂−φ₁) of vibrators 104, 104b is controlled to be 0 or π, food 101 may be controlled to move in line along the bottom of container 102; when the phase change (φ₂−φ₁) of vibrators 104, 104b is controlled to be π/4, π/2, 3π/4, π, 5π/4, 3π/2 or 7π/4, food 101 may be controlled to move in ellipse clockwise or counter-clockwise along the bottom of container 102. Furthermore, when the vibration amplitude A₁ of vibrator 104a is controlled to be equal to the vibration amplitude A₂ of vibrator 104b, and the phase change (φ₂−φ₁) of vibrators 104, 104b is controlled to be π/2 or 3π/2, food 101 may be controlled to move in circle clockwise or counter-clockwise.

During cooking, controller 105 may control, in response to a trigger, vibrators 104a, 104b to generate vibration to cause food 101 to move along the bottom of container 102 in a first mode (e.g., A₁≠A₂, φ₂−φ₁=π/4); then in response to another trigger, for example a predetermined duration has elapsed or a mode-changing signal input by the user has been received, controller 105 may further adjust, in accordance with the control strategy, the phase change (φ₂−φ₁) and the vibration amplitudes A₁, A₂ and then control vibrators 104a, 104b to generate vibration to cause food 101 to move along the bottom of container 102 in a second mode (e.g., A₁=A₂, φ₂−φ₁=π/2) based on the adjusted parameters. It shall be appreciated that in other embodiments, controller 105 may only adjust the phase change (φ₂−φ₁) of vibrators 104a, 104b or the vibration amplitudes A₁ and A₂ of vibrators 104a, 104b. It is also to be noted that during the whole cooking procedure, controller 105 may change the movement track of food 101 for several times as desired or as required.

Advantageously, controller 105 may also control the heating time and/or heating temperature of heater 103, cooperating with the operation of vibration generator 104. For example, the control strategy may be moving food 101 in circle clockwise and meanwhile heating food 101 at 80° C. for 3 minutes and then moving food 101 in circle counter-clockwise and meanwhile heating food 101 at 60° C. for 5 minutes. Take vibrators 104a, 104b as an example, when cooker 100 is activated, based on such a control strategy, controller 105 may first adjust the vibration amplitudes A₁, A₂ of the vibrators 104a, 104b to be equal and adjust the phase change (φ₂−φ₁) of vibrators 104, 104b to be π/2 and then control vibrators 104a, 104b to vibrate container 102 according to the adjusted parameters. Meanwhile, controller 105 may control heater 103 to heat food 101 in container 102 at 80° C. At the same time, a timer of controller 105 may start counting. When the timer expires, i.e., 3-minute elapses, the controller 105 may further adjust the phase change (φ₂−φ₁) of vibrators 104, 104b to be 3π/2 and then control vibrators 104a, 104b to vibrate container 102 according to the adjusted parameter. Meanwhile, controller 105 may control heater 103 to heat food 101 in container 102 at 60° C. After 5-minute passes, controller 105 may control vibrators 104a, 104b to stop vibrating and control heater 103 stop heating, and the entire cooking procedure is over. It is to be noted that in other embodiments the control of heating time and/or heating temperature may also be in combination with the control of vibrator 104′ as shown in FIG. 3a or in combination with electromagnetic vibrator 104″ as shown in FIG. 3b, which will not be described herein for conciseness.

As in one embodiment, both of the first vibrator 104a and the second vibrator 104b are eccentric vibrators. Both eccentric vibrators 104a, 104b are solidity coupled with the container 102, and the container 102 or the vibration generators 104 is flexibly supported by a spring. The first horizontal direction has an angle related to the second horizontal direction, advantageously the first horizontal direction is perpendicular to the second horizontal direction. The plurality of movement modes/tracks of food 101 may be achieved by adjusting the phase change of eccentric vibrators 104a, 104b and/or vibration amplitudes of eccentric vibrators 104a, 104b separately.

As in another embodiment, both of the first vibrator 104a and the second vibrator 104b are electromagnetic vibrators. The electromagnetic vibrators 104a, 104b comprise a magnet and two electromagnetic coils. The magnet solidity coupled with the container 102, and the magnet or the container 102 is flexibly supported by a spring. The first horizontal direction has an angle related to the second horizontal direction, advantageously the first horizontal direction is perpendicular to the second horizontal direction. The plurality of movement modes/tracks of food 101 may be achieved by adjusting the phase change of electromagnetic vibrators 104a, 104b and/or magnetic intensity of the electromagnetic vibrators 104a, 104b separately.

The control strategy may be pre-stored in a storage of controller 105. In one example, the whole cooking procedure may be finished automatically without any user interaction during cooking. In this case, cooker 100 may provide a plurality of buttons on its user interface, each of which indicating one kind of dish, and the control strategy corresponding to different kinds of dishes may have been pre-stored in the storage of controller 105. The user may first put raw materials and ingredients into container 102 and then select one button corresponding to the desired kind of dish; thereby cooker 101 begins to cook based on the pre-stored control strategy. In other example, the cooker 100 may provide several buttons on its user interface, each of which indicating one movement mode/track of food, and the control strategy corresponding to each movement mode/track may have been pre-stored in the storage of controller 105. In this example, the user may select different movement modes/tracks as desired during cooking, and cooker 101 may cook food based on the user's selection.

Alternatively, the user may define his/her own control strategy for dishes by selecting different movement modes, heating time, heating temperature and so forth. The selection may then be stored in the storage of controller 105 as a control strategy which will be used later during cooking.

Alternatively, cooker 101 may provide a learning mode. The user may manually cook the food and cooker 101 may record the whole cooking procedure and generate the control strategy which can be used while cooking the same kind of dish next time.

Advantageously, cooker 100 may further comprise a sensor (not shown) configured to measure the internal temperature of container 102 and provides the measurement results to controller 105. Controller 105 may control the heating power of heater 103 or perform other operations based on the measurement results received from the sensor.

FIG. 6 shows a flow chart of a method of cooking food in a container. Referring to FIG. 6, the method comprises the step 61 of heating the food in the container, and a step 62 of controlling a vibration generator to vibrate the container so as to cause the food in the container to move horizontally during the heating process.

Advantageously, the vibration generator comprises a first vibrator, and the controller is configured to control the first vibrator to vibrate the container to cause food reciprocating movement in a first horizontal direction in the container; the vibration generator further comprises a second vibrator, and the controller is further configured to control the second vibrator to vibrate the container to cause food reciprocating movement in a second horizontal direction in the container, and the second horizontal direction has an angle related to the first horizontal direction; the controller is further configured to adjust the phase change and/or vibration amplitude of the first and second vibrators separately, so as to change the movement track of the food in the container.

In one embodiment, the vibration generator may comprise an eccentric vibrator, an electromagnetic vibrator and so forth.

When the vibration generator comprises an eccentric vibrator, the method may further comprise the step of: adjusting the vibration amplitude of the vibrator so as to change the movement diameter of the food in the horizontal direction.

When the vibration generator comprises an electromagnetic vibrator, the method may further comprise the step of: adjusting the magnetic intensity of the electromagnetic vibrator so as to change the movement diameter of the food in the horizontal direction.

In another embodiment, the vibration generator may comprise at least two eccentric vibrators, two electromagnetic vibrators and so forth.

When the vibration generator comprises two eccentric vibrators perpendicular to each other, the method may further comprise the step of: adjusting the phase change and/or vibration amplitudes of the two eccentric vibrators separately, so as to change the movement track of the food.

When the vibration generator comprises two electromagnetic vibrators perpendicular to each other, the method may further comprise the step of: adjusting the phase change and/or magnetic intensity of the two electromagnetic vibrators separately, so as to change the movement track of the food.

It should be noted that the above described embodiments are given for describing rather than limiting the invention, and it is to be understood that modifications and variations may be resorted to without departing from the spirit and scope of the invention as those skilled in the art readily understand. Such modifications and variations are considered to be within the scope of the invention and the appended claims. The protection scope of the invention is defined by the accompanying claims. In addition, any of the reference numerals in the claims should not be interpreted as a limitation to the claims. Use of the verb “comprise” and its conjugations does not exclude the presence of elements or steps other than those stated in a claim. The indefinite article “a” or “an” preceding an element or step does not exclude the presence of a plurality of such elements or steps.

1. A cooker, comprising:
a container, configured to receive food;
a vibration generator coupled with the container, configured to generate vibration;
a controller coupled with the vibration generator, configured to control the vibration generator to vibrate the container to cause food movement horizontally in the container,
wherein the vibration generator comprises a first vibrator, and the controller is configured to control the first vibrator to vibrate the container to cause food reciprocating movement in a first horizontal direction in the container; and the vibration generator further comprises a second vibrator, and the controller is further configured to control the second vibrator to vibrate the container to cause food reciprocating movement in a second horizontal direction in the container, and the second horizontal direction has an angle related to the first horizontal direction.

2. (canceled)

3. (canceled)

4. The cooker of claim 1, wherein the controller is further configured to adjust the phase change and/or vibration amplitude of the first and second vibrators separately, so as to change the movement track of the food in the container.

5. The cooker of claim 4, wherein the first horizontal direction is perpendicular to the second horizontal direction.

6. The cooker of claim 1, wherein the first vibrator is an eccentric vibrator, and the controller is configured to adjust the vibration amplitude of the eccentric vibrator so as to change the movement diameter of the food.

7. The cooker of claim 1, wherein the first and the second vibrator are eccentric vibrators, and the controller is configured to adjust the phase change and/or vibration amplitude of the eccentric vibrators separately, so as to change the movement track of the food.

8. The cooker of claim 6, wherein the vibration generator is solidity coupled with the container, and the container or the vibration generator is flexibly supported by a spring.

9. The cooker of claim 1, wherein the first vibrator is an electromagnetic vibrator, and the controller is configured to adjust the magnetic intensity of the electromagnetic vibrator, so as to change the movement diameter of the food.

10. The cooker of claim 9, wherein the electromagnetic vibrator comprising a magnet and an electromagnet; the magnet solidity coupled with the container, and the magnet or the container is flexibly supported by a spring.

11. The cooker of claim 1, wherein the first and the second vibrator are electromagnetic vibrators, and the controller is configured to adjust the phase change and/or magnetic intensity of the electromagnetic vibrators separately, so as to change the movement track of the food.

12. The cooker of claim 11, wherein the electromagnetic vibrators comprising a magnet and two electromagnets; the magnet solidity coupled with the container, and the magnet or the container is flexibly supported by a spring.

13. The cooker of any one of claim 1, further comprising a heater coupled with the container, configured to heat the food in the container, wherein the controller is further configured to control the heating time and heating temperature, cooperating with the operation of the vibration generator.

14. A method of cooking food in a container, the method comprising the steps of:
heating the food in the container;
controlling a vibration generator to vibrate the container so as to cause the food in the container to move horizontally during the heating process,
wherein
the vibration generator comprises a first vibrator, and the controller is configured to control the first vibrator to vibrate the container to cause food reciprocating movement in a first horizontal direction in the container;
the vibration generator further comprises a second vibrator, and the controller is further configured to control the second vibrator to vibrate the container to cause food reciprocating movement in a second horizontal direction in the container, and the second horizontal direction has an angle related to the first horizontal direction;
the controlled is further configured to adjust the phase change and/or vibration amplitude of the first and second vibrators separately, so as to change the movement track of the food in the container.

15. (canceled)
